(19) United States
(12) Patent Application Publication
(10) Pub. No.: US 2025/0272673 A1
(43) Pub. Date: Aug. 28, 2025

(54) SYSTEMS AND METHODS OF SECURE MERCHANT PAYMENT OVER MESSAGING PLATFORM USING A CONTACTLESS CARD

(71) Applicant: Capital One Services, LLC, McLean, VA (US)

(72) Inventors: Kevin OSBORN, Newton Highlands, MA (US); Jeffrey RULE, Chevy Chase, MD (US); Rajko ILINCIC, Annandale, VA (US)

(21) Appl. No.: 19/074,031

(22) Filed: Mar. 7, 2025

Related U.S. Application Data
(63) Continuation of application No. 18/120,513, filed on Mar. 13, 2023, now Pat. No. 12,248,928.

(51) Int. Cl. G06Q 20/34; G06F 9/54; G06Q 20/38; G06Q 20/40

(52) U.S. Cl. CPC G06Q 20/352; G06F 9/547; G06Q 20/386; G06Q 20/401

(57) ABSTRACT

A method is provided including receiving, by a server from a user device, a cryptogram of a contactless card, wherein the user device receives a payment request message from a merchant device, and the user device receives the cryptogram from a contactless card upon tapping the contactless card to the user device. The method further includes validating and decrypting, by the server, the cryptogram, extracting, by the server, from the decrypted cryptogram a unique customer identifier associated with the user, and verifying, by the server, the unique customer identifier. The method further includes retrieving, by the server from a database, account information of the user, calling, by the server, one or more application programming interfaces (APIs) of the merchant device to make a payment in response to the payment request message, and provisioning, by the server, the account information to the merchant device via the APIs.

### CROSS-REFERENCE TO RELATED APPLICATION

This patent application is a continuation of and claims the benefit of priority to U.S. patent application Ser. No. 18/120,513, filed Mar. 13, 2023 (now U.S. Pat. No. 12,248,928), the contents of which are incorporated by reference herein in their entirety.

### FIELD OF THE INVENTION

The present disclosure relates generally to data and payment security, and more particularly, to systems and methods for a secure merchant payment over a messaging platform using a contactless card.

### BACKGROUND

Invoicing customers is a key element of conducting payment transactions with customers. Data security and transaction integrity are of critical importance to businesses, merchants, and consumers. Customers are usually authenticated using multiple factors when transactions and/or payments are being conducted. Email may be used as one authentication factor to verify customers and/or transactions, but email is susceptible to attack and vulnerable to hacking or other unauthorized access. Short message service (SMS) messages may also be used, but that is subject to compromise as well.

A photo identification (ID) (e.g., a government-issued ID) can be presented as a second authentication factor, however, this does not work or is inconvenient for online transactions or for non-face-to-face transactions.

In addition, a particular challenge is setting up fast and secure payment channels. Merchants seeking to receive customer payments must provide a secure way to facilitate payments in a manner that does not degrade the customer experience.

These and other deficiencies exist. Accordingly, there is a need to provide systems and methods that overcome these deficiencies to invoice customers or perform payments using a more secure and fast way such as a contactless card as one authentication factor for a multiple factor authentication.

### SUMMARY

Aspects of the disclosed technology include systems and methods of authenticating a user using a contactless card as one authentication factor for multiple factor authentication.

Embodiments of the present disclosure provide a method for secure merchant payment over a messaging platform based on a contactless card. The method comprises: receiving, by a server from a user device, a cryptogram of a contactless card, wherein the user device receives a payment request message from a merchant device, and the user device receives the cryptogram from the contactless card upon taping the contactless card to the user device by a user prompted by the payment request message; validating, by the server, the cryptogram; extracting, by the server, from the cryptogram a unique customer identifier associated with the user; verifying, by the server, the unique customer identifier; retrieving, by the server from a database, account information of the user; and calling, by the sever, one or more application programming interfaces (APIs) of the merchant device to make a payment in response to the payment request message; and provisioning, by the server, the account information to the merchant device via the APIs.

Embodiments of the present disclosure provide a system for secure merchant payment over a messaging platform based on a contactless card. The system comprises a server. The server is configured to: receive, from a user device, a cryptogram of a contactless card, wherein the user device receives a payment request message from a merchant device, and the user device receives the cryptogram from the contactless card upon taping the contactless card to the user device by a user prompted by the payment request message; validate the cryptogram; extract, from the cryptogram, a unique customer identifier associated with the user; verify the unique customer identifier; retrieve, from a database, account information of the user; and call one or more application programming interfaces (APIs) of the merchant device to make a payment in response to the payment request message; and provision the account information to the merchant device via the APIs.

Embodiments of the present disclosure provide a non-transitory, computer-readable medium comprising instructions for secure merchant payment over a messaging platform based on a contactless card that, when executed on a computer arrangement, perform actions comprising: receiving, from a user device, a cryptogram of a contactless card, wherein the user device receives a payment request message from a merchant device, and the user device receives the cryptogram from the contactless card upon taping the contactless card to the user device by a user prompted by the payment request message; validating the cryptogram; extracting, from the cryptogram, a unique customer identifier associated with the user; verifying the unique customer identifier; retrieving, from a database, account information of the user; and call one or more application programming interfaces (APIs) of the merchant device to make a payment in response to the payment request message; and provisioning the account information to the merchant device via the APIs.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for secure merchant payments using a contactless card as an authentication factor according to an example embodiment.

FIG. 2 is a diagram of sequential interactions between components of the system in FIG. 1 according to an example embodiment.

FIG. 3A is a contactless card used for secure merchant payment as an authentication factor according to an example embodiment.

FIG. 3B is a diagram of the processor of the contactless card in FIG. 3 according to an example embodiment.

FIG. 4A is a diagram of a message flow chart for secure merchant payments using a contactless card as an authentication factor according to an example embodiment.

FIG. 4B is a diagram of a message flow chart for secure merchant payments using a contactless card as an authentication factor according to an example embodiment.

FIG. 5 is a flow chart of a method for secure merchant payments using a contactless card as an authentication factor according to an example embodiment.

FIG. 6 is a flow chart of a method for secure merchant payments using a contactless card as an authentication factor according to an example embodiment.

FIG. 7 is a flow chart of a method for secure merchant payments using a contactless card as an authentication factor according to an example embodiment.

FIG. 8 is a flow chart of a method for secure merchant payments using a contactless card as an authentication factor according to an example embodiment.

FIG. 9 is a flow chart of a method for secure merchant payments using a contactless card as an authentication factor according to an example embodiment.

FIG. 10 is a flow chart of a method for secure merchant payments using a contactless card as an authentication factor according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described are recognized as capable of implementation separately, or in combination, with other embodiments from the description of the embodiments and features and teachings of any embodiment can be interchangeably combined with the features and teachings of any other embodiment. A person of ordinary skill in the art reviewing the description of embodiments will be able to learn and understand the different described aspects of the invention. The description of embodiments will facilitate understanding of the invention to such an extent that other implementations, not specifically covered but within the knowledge of a person of skill in the art having read the description of embodiments, would be understood to be consistent with an application of the invention.

As described above, invoicing customers requires a secure and fast payment channel. Example embodiments of the present disclosure provide systems and methods for invoicing customers using a contactless card as one authentication factor. The present invention can use a contactless card platform to enable payment and/or invoicing via SMS in a secure and fast way.

The present invention can also simplify the customers' ability to pay and the merchants to collect payments in a seamless way. This allows for creating trust between the customers and the merchants with the leverage of the contactless card platform and leveraging modern technical infrastructure.

In the present disclosure, a two step process may be employed for the invention. In a first step, a trust may be created via SMS text messages and mobile carriers or other trust issuer, which can certify that the message ID is from the original merchant. The SMS message may contain a universal link (e.g., a deep link or app clip) and a transaction ID may also be sent and/or included in the SMS message. After the initial SMS message is verified, the customer is able to see or view the SMS message. In a second step, choices for one time or stored card recurring payments can be offered and recorded by the merchant via SMS text response supplying payment information. In some embodiments, a backend integration is employed. In these embodiments, the merchant may send an invoice and/or payment total in an SMS message with a link (e.g., a universal resource locator (URL)) to a user device of the user. The link, also referred to as an universal link, may trigger the download (or if already cached) activation of app or app clip and/or instant app on the user device (such as a mobile phone). Parameters on this URL may indicate the merchant and some type of transaction ID. The instant app and/or app clip may prompt the customer and/or user to tap his or her contactless card to the user device. A cryptogram message generated by the contactless card is sent to the validation and/or commerce server where the cryptogram message is validated, and the financial account information of the user is looked up and then provisioned into the merchant via application programming interfaces (APIs) of the merchant. The APIs on the merchant server can be called with the card number, identifying information and/or transaction ID. The transaction is then executed to make the payment. The merchant may then send a text message with payment confirmation back to the user device. In some embodiments, a messaging app integration is employed. In these embodiments, the messaging app is modified to receive payment information from the app clip or incorporated software development kit (SDK) with the contactless card logics. The received information, such as a primary account number (PAN) and/or virtual card number (VCN) of the contactless card, may be sent via a SMS message from the user device to the merchant device. The payment information can be encrypted with the public key used to establish the merchant trust in the SMS message and then decrypted on the merchant's SMS payment processing gateway with the corresponding private key.

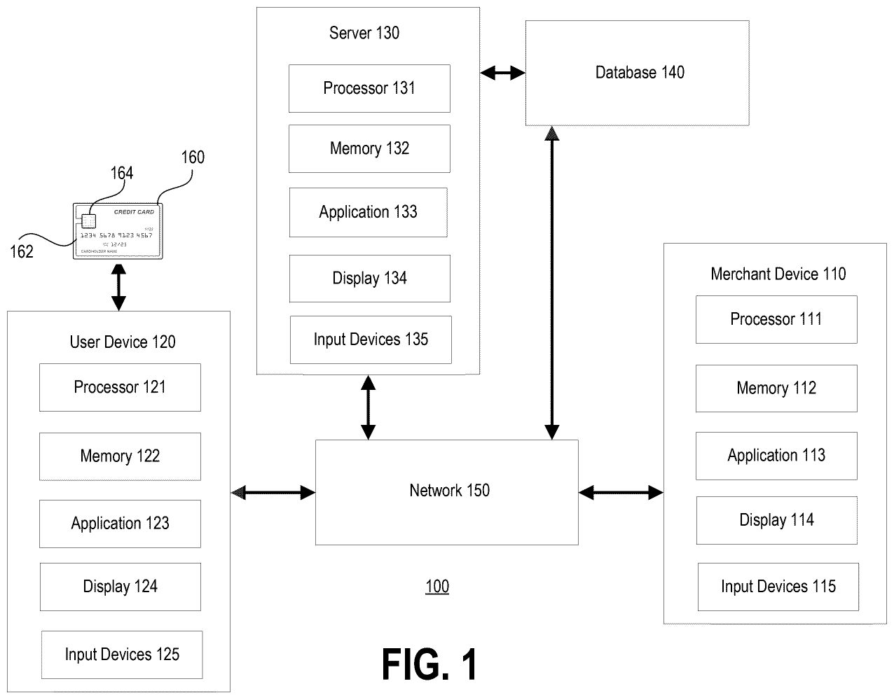

FIG. 1 illustrates a system 100 for invoicing a consumer using a contactless card as an authentication factor according to an example embodiment. As further discussed below, the system 100 may include a merchant device 110, a user device 120, a server 130, a database 140 in communication using a network 150, and a contactless card 160 in signal communication with the user device 120. Although FIG. 1 illustrates single instances of the components, the system 100 may include any number of components.

The merchant device 110 may be associated with a merchant with which the transactions are conducted by the user through the user device 120, for example, online purchases made from the merchant. The merchant device 110 can be configured to store the online merchant accounts, and to present a shopping interface on which the user can conduct the transactions with the merchant.

The merchant device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The merchant device 110 may include a processor 111, a memory 112, and an application 113. The processor 111 may be a processor, a microprocessor, or other processor, and the merchant device 110 may include one or more of these processors. The processor 111 may include processing circuitry, which may contain additional components, including additional processors, memories, error and parity and/or CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the merchant device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's shopping and financial account information.

The application 113 may comprise one or more software applications comprising instructions for execution on the merchant device 110. In some examples, the merchant device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. For example, the application 113 may be executed to perform invoicing the user or receiving payment information from the server 130. The application 113 may also be executed to perform processing transactions of a user who may shop online from the merchant. Such processes may be implemented in software, such as software modules, for execution by computers or other machines. The application 113 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The merchant device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the merchant device 110 that is available and supported by the merchant device 110, such as a touch-screen, keyboard, mouse, cursor-control device, touch-screen, microphone, digital camera, video recorder or camcorder. These devices may be used to enter information and interact with the software and other devices described herein.

The user device 120 can be used by a user to initiate and/or perform transactions with the merchant device 110. The user device 120 may be configured to present to the user a user interface from which the user may log into, for example, their bank or credit card account to access their transaction statement and/or financial information stored in the database 140 of the server 130. The user interface may also be configured to perform data communication with the contactless card 160. The user device 120 may be configured to display on the user interface a merchant's website, in response to a selection by the user of accessing the merchant's website.

The user device 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 120 may include a processor 121, a memory 122, an application 123, a display 124, and input devices 125. The processor 121 may be a processor, a microprocessor, or other processor, and the user device 120 may include one or more of these processors. The processor 121 may include processing circuitry, which may contain additional components, including additional processors, memories, error and parity and/or CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the user device 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the user device 120. In some examples, the user device 120 may execute one or more applications, such as software applications, that enable, for example, network communications with one or more components of the system 100, transmit and/or receive data, and perform the functions described herein such as presenting the online website to the user of the user device 120 and reading the contactless card 160. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system.

The user device 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the user device 120 that is available and supported by the user device 120, such as a touch-screen, keyboard, mouse, cursor-control device, touch-screen, microphone, digital camera, video recorder or camcorder. These devices may be used to enter information and interact with the software and other devices described herein such as selecting an option of creating an online account with the merchant.

The server 130 may be associated with an institution, such as a financial institution, and can be configured to communicate with the merchant device 110 and the user device 120. The institution associated with the server 130 may issue the contactless card 160 to the user and accordingly may authenticate the user based on the contactless card 160.

The server 130 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 130 may include a processor 131, a memory 132, and an application 133. The processor 131 may be a processor, a microprocessor, or other processor, and the server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the server 130. In some examples, the server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described below. For example, the card authentication module of the application 133 may be executed to perform authenticating the user based on the contactless card 160. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the server 130 that is available and supported by the server 130, such as a touch-screen, keyboard, mouse, cursor-control device, touch-screen, microphone, digital camera, video recorder or camcorder. These devices may be used to enter information and interact with the software and other devices described herein.

The database 140 may be one or more databases configured to store date, including without limitation, private information of users, financial accounts of users, contactless card information, online merchant account information, transactions of users, and merchant records indicative of corresponding merchants. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 130 or may be hosted externally of the server 130, such as by a server, by a cloud-based platform, or in any storage device that is in data communication with the server 130.

The system 100 may include one or more networks 150. In some examples, the network 150 may be one or more of a wireless network, a wired network or any combination of wireless network and wired network, and may be configured to connect the merchant device 110, the user device 120, the server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the merchant device 110, server 130, and user device 120 using the network 150 can occur using one or more front channels and one or more secure back channels. A front channel may be a communication protocol that employs a publicly accessible and/or unsecured communication channel such that a communication sent to the merchant device 110, server 130, and/or user device 120 may originate from any other device, whether known or unknown to the merchant device 110, server 130, and/or user device 120, if that device possesses the address (e.g., network address, Internet Protocol (IP) address) of the merchant device 110, server 130, and/or user device 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the merchant device 110, server 130, and/or user device 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

The contactless card 160 may be any type of card, such as a security card, a payment card, an identification card, and the like. The contactless card 160 may be issued to the user by the financial institution for identity verification for the bank account of the user.

The contactless card 160 can be configured to transmit a cryptogram to the user device 120 upon tapping to the user device 120. The user device 120 may be configured to read the cryptogram from the contactless card 160 after entry of the contactless card 160 into a communication field of the user device 120. The user device 120 may then transmit the cryptogram to the server 130. The server 130 may be configured to verify the cryptogram by searching the database 140.

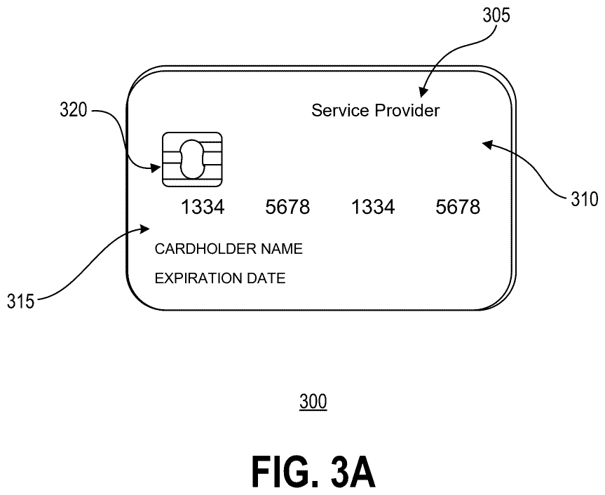

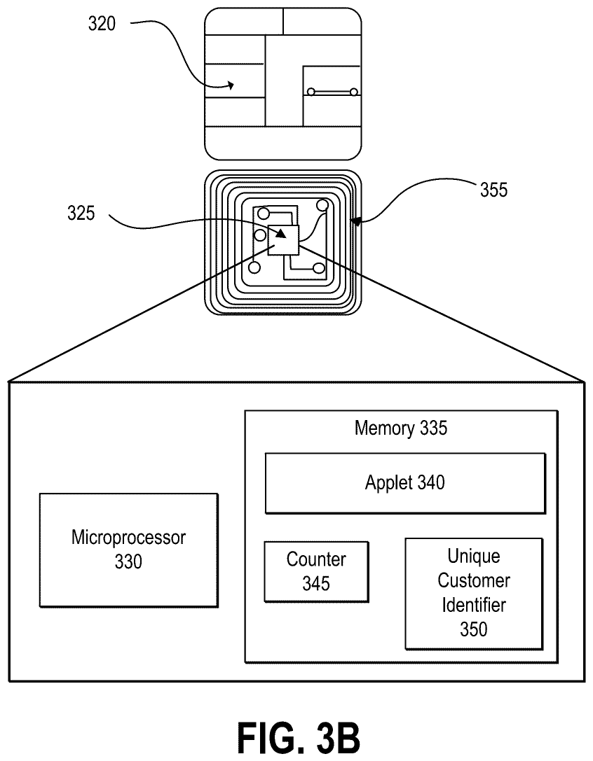

The contactless card 160 can perform authentication and numerous other functions that may otherwise require a user to carry a separate physical token in addition to the contactless card 160. By employing a contactless interface, the contactless card 160 may be provided with a method to interact and communicate between a user's device (such as a mobile phone or the user device 120) and the card itself. For example, the Europay, Mastercard, and Visa (EMV) protocol, which underlies many credit card transactions, includes an authentication process which suffices for operating systems for Android® but presents challenges for iOS®, which is more restrictive regarding near field communication (NFC) usage, as it can be used only in a read-only manner. Exemplary embodiments of the contactless card 160 described herein utilize NFC technology. The contactless card 160 may comprise a substrate 162 and a contact pad 164. Details of an example contactless card will be described in FIGS. 3A and 3B.

In some examples, exemplary procedures in accordance with the present disclosure described herein can be performed by a computer hardware arrangement. Such a computer hardware arrangement can be, for example entirely or a part of, or include, but not limited to, a computer and/or processor that can include, for example one or more microprocessors, and use instructions stored on a non-transitory computer-accessible medium (e.g., RAM, ROM, hard drive, or other storage device). For example, a computer-accessible medium can be part of the memory of the merchant device 110, user device 120, server 130, and contactless card 160, or other computing and/or processing arrangement.

In some examples, a computer-accessible medium (e.g., as described herein, a storage device such as a hard disk, floppy disk, memory stick, CD-ROM, RAM, ROM, etc., or a combination thereof) can be provided (e.g., in communication with the computer hardware arrangement). The computer-accessible medium can contain executable instructions thereon. In addition or alternatively, a storage arrangement can be provided separately from the computer-accessible medium, which can provide the instructions to the computer hardware arrangement. The instructions can configure the computer hardware arrangement to execute certain exemplary procedures, processes, and methods, as described herein above, for example.

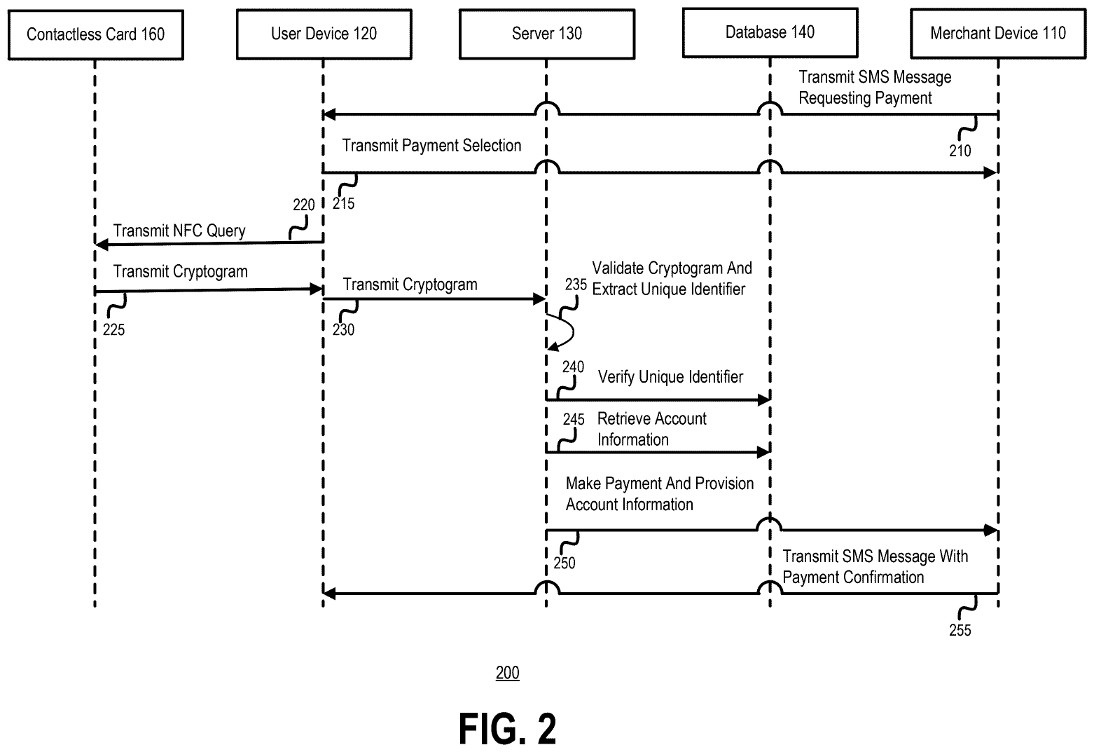

FIG. 2 illustrates an example diagram 200 of sequence interaction between the components of the system 100 according to an example embodiment. FIG. 2 may reference the same or similar components as those illustrated in FIG. 1, including a user device, a server, a database, a merchant device and a contactless card.

When a user wants to make an online purchase from a merchant, the user may use the user device 120 to log into his or her online account with the merchant that is associated with the merchant device 110. In those example embodiments, the merchant device 110 may invoice the user by transmitting to the user device 120 a SMS message requesting a payment for the transaction at step 210. The SMS message is transmitted through the carrier of the user device 120 (such as a mobile phone carrier offering SMS text message service), thus the SMS message can be certified to be from the merchant, whereby a trust is created between the merchant and the user. The SMS message may contain a universal link (e.g., a deep link or app clip), and/or a transaction ID indicating the transaction. The SMS message may also include payment choices, such as a one-time payment or a stored card recurring payment. At step 215, the user may select a payment option from the payment choices, and transmit through the user device 120 the payment selection to the merchant device 110.

The universal link in the SMS message may then open up a mobile app or mobile app process on the user device 120 from which the contactless card 160 can be read in that mobile app. If the mobile app is not already installed on the user device 120, the link may trigger a download activation to download the mobile app and install it on the user device 120. The user may use the user device 120 to transmit an NFC prompt and/or query to the contactless card 160 at step 220. The user device 120 may include an NFC interface configured for establishing an NFC communication with other NFC-equipped devices (the contactless card 160 in this embodiment). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the contactless card 160 transmits, at step 225 to the user device 120 NFC response information (e.g., a cryptogram) usable by the server 130 to authenticate the user and/or contactless card. The NFC response information may be or include, for example, security information encrypted by the contactless card 160 using a private key unique to the card that is known only to the card account administrator (the server 130). The cryptogram may be stored in the memory of the contactless card 160. The cryptogram includes the unique identifier of the contactless card 160.

At step 230, the user device 120 transmits the NFC response information (the cryptogram) to the server 130. At step 235, the server 130 receives the cryptogram from the user device 120. The server 130 validates the cryptogram, decrypts the cryptogram and extracts the unique identifier of the contactless card 160 through the card authentication module of the server 130. When the server receives the cryptogram, the server may decrypt the cryptogram before or after verifying the cryptogram. The server 130 may then extract the unique identifier of the contactless card 160 which is uniquely associated with the user. At step 240, the server 130 may verify the unique identifier of the contactless card 160 by searching the database 140. Then at step 245, the server 130 may retrieve account information of a financial and/or card account based on the unique identifier of the contactless card 160 from the database 140. The account information may include, but is not limited to, a PAN of the financial and/or card account, a VCN of the card, a home address of the user, a mailing address of the user, a phone number of the user, a billing address of the user, and so forth.

At step 250, the server 130 may make a payment for the transaction to the merchant based on the account information of the user. The payment may be a one-time payment according to the user selection of payment choices. If the payment is a recurring payment or the user would like to have his or her account information stored with the merchant, the server 130 may provision the account information to the merchant device 110. The server 130 may call APIs of the merchant device to make the payment and/or provision the account information. In some embodiments, the server 130 may make the payment and/or provision the account information via one or more SMS messages to the merchant device 110.

At step 255, the merchant device 110 may transmit a SMS message including a payment confirmation to the user via the user device 120. After the merchant device 110 receives the payment from the server 130, the merchant device 110 may notify the user of the payment by transmitting the SMS message including the payment confirmation to the user device 120.

As described above, when the user uses the user device 120 to initiate a transaction with the merchant device 110 and then receives a payment request via a SMS message including a link from the merchant device 110, the user can be directed to use a mobile app installed on the user device or downloaded to the user device to read the contactless card 160 for authenticating the user for making the payment and/or provisioning the account information. The SMS message with the link would open up the mobile app or mobile app process and the user would be able to read the contactless card 160 in that mobile app and then that contactless card data would go back to the server 130, so the server 130 would be able to verify the user using the contactless card 160 for making the payment and/or provisioning the account information.

In some embodiments, the link with a deep link may be transmitted into the mobile app of the user device 120, and the user can follow the link to tap the contactless card 160. In such scenarios, the user does not have to fully log in the mobile app installed on the user device 120. The user just taps the contactless card 160 to the user device 120 and the server 130 is going back to verify the user using the contactless card 160 for making the payment and/or provisioning the account information.

FIG. 3A describes a contactless card 300 that can be used for authenticating the user and making the payment in the system 100 of FIG. 1. The contactless card 160 in FIG. 1 can be the contactless card 300 described herein. The contactless card 300 is configured to communicate with the user device 120 of system 100. The contactless card 300 may comprise a payment card, such as a credit card, debit card, or gift card, issued by a service provider 305 (such as a bank associated with the server 130) displayed on the front or back of the contactless card 300. In some examples, the contactless card 300 is not related to a payment card, and may comprise, without limitation, an identification card, a membership card, and a transportation card. In some examples, the contactless card 300 may comprise a dual interface contactless payment card.

The contactless card 300 may comprise a substrate 310, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 300 may have physical characteristics compliant with the ID-1 format of the ISO/IEC 7810 standard, and the contactless card 300 may otherwise be compliant with the ISO/IEC 14443 standard. However, it is understood that the contactless card 300 according to the present disclosure may have different characteristics, and the present disclosure does not require the contactless card 300 to be implemented in a payment card.

The contactless card 300 may also include identification information 315 displayed on the front and/or back of the contactless card 300, and a contact pad 320. The contact pad 320 may be configured to establish contact with another communication device, such as a user device, smart phone, laptop, desktop, or tablet computer. The contactless card 300 may also include processing circuitry, antenna and other components. These components may be located behind the contact pad 320 or elsewhere on the substrate. The contactless card 300 may also include a magnetic strip or tape, which may be located on the back of the contactless card 300.

FIG. 3B illustrates an example contact pad 320 of the contactless card 300. The contact pad 320 of the contactless card 300 may include processing circuitry 325 for storing and processing information, including a processor 330 and a memory 335. It is understood that the processing circuitry 325 may contain additional components, including processors, memories, error and parity and/or CRC checkers, data encoders, anticollision algorithms, controllers, command decoders, security primitives and tamperproofing hardware, as necessary to perform the functions described herein.

The memory 335 may be a read-only memory, write-once read-multiple memory or read/write memory, e.g., RAM, ROM, and EEPROM, and the contactless card 300 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

In some embodiments, the memory 335 may also have stored public and private card encryption keys. In some embodiments, the private and public encryption keys may be permanently hard-wired into the card memory 335. In various embodiments, the memory 335 may have stored therein instructions for generating encrypted information and transmitting it to a receiving device (e.g., the user device 120). Such encrypted information may be or include an encrypted verification block or signature that may be used to authenticate and verify the presence of the card 300 during transaction processing. In some embodiments, encrypted information may be unique to a particular communication (e.g., a particular NFC transmission by the card 300).

The memory 335 may be configured to store one or more applets 340, one or more counters 345, and a unique customer identifier 350. The one or more applets 340 may comprise one or more software applications configured to execute on one or more contactless cards, such as Java Card applet. However, it is understood that the one or more applets 340 are not limited to Java Card applets, and instead may be any software application operable on contactless cards or other devices having limited memory. The one or more counters 345 may comprise a numeric counter sufficient to store an integer. The unique customer identifier 350 may comprise a unique alphanumeric identifier assigned to a user of the contactless card 300, and the identifier may distinguish the user of the contactless card 300 from other contactless card users. In some examples, the customer identifier 350 may identify both a customer and an account assigned to that customer and may further identify the contactless card 300 associated with the customer's account.

The processor 330 and memory 335 elements of the foregoing exemplary embodiments are described with reference to the contact pad 320, but the present disclosure is not limited thereto. It is understood that these elements may be implemented outside of the contact pad 320 or entirely separate from it, or as further elements in addition to the processor 330 and the memory 335 elements located within the contact pad 320.

In some examples, the contactless card 300 may comprise one or more antennas 355. The one or more antennas 355 may be placed within the contactless card 300 and around the processing circuitry 325 of the contact pad 320. For example, the one or more antennas 355 may be integral with the processing circuitry 325 and the one or more antennas 355 may be used with an external booster coil. As another example, the one or more antennas 355 may be external to the contact pad 320 and the processing circuitry 325.

In an embodiment, the coil of contactless card 300 may act as the secondary of an air core transformer. A terminal (such as the user device 120) may communicate with the contactless card 300 by cutting power or amplitude modulation. The contactless card 300 may infer the data transmitted from the terminal using the gaps in the contactless card's power connection, which may be functionally maintained through one or more capacitors. The contactless card 300 may communicate back by switching a load on the contactless card's coil or load modulation. Load modulation may be detected in the terminal's coil through interference.

As explained above, the contactless card 300 may be built on a software platform operable on smart cards or other devices having limited memory, such as JavaCard, and one or more or more applications or applets (applet 340) may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader (the user device 120), and produce an NDEF message that comprises a cryptographically secure OTP encoded as an NDEF text tag.

The contactless card 300 may be configured for communication with the user device 120 via a communication interface configured for establishing communication with the user device 120. The communication interface may be configured for contact-based communication, in which case the interface may have electrical circuitry and contact pads on the surface of the card 300 for establishing direct electrical communication between the card 300 and the user device 120. Alternatively or in addition, the communication interface may be configured for contactless communication with the user device 120. In such embodiments, the communication interface may be or include an NFC communication interface configured for communication with other NFC communication devices when the card 300 is within a predetermined NFC range. In some embodiments, the card 300 may include a second communication interface configured for establishing short range communication with the user device 120 via Bluetooth, or other short range communication methodology. In such embodiments, the card 300 may have a short range communication antenna that is included in or connected to the short range communication interface. The card 300 may also include a power management system for use in managing the distribution of power during an NFC transaction.

The contactless card 300 can be configured to transmit a cryptogram to the user device 120 upon tapping to the user device 120. The user device 120 may be configured to read the cryptogram from the contactless card 300 after entry of the contactless card 300 into a communication field of the user device 120. The user device 120 may then transmit the cryptogram to the server 130. The server 130 may be configured to verify the cryptogram by searching the database 140.

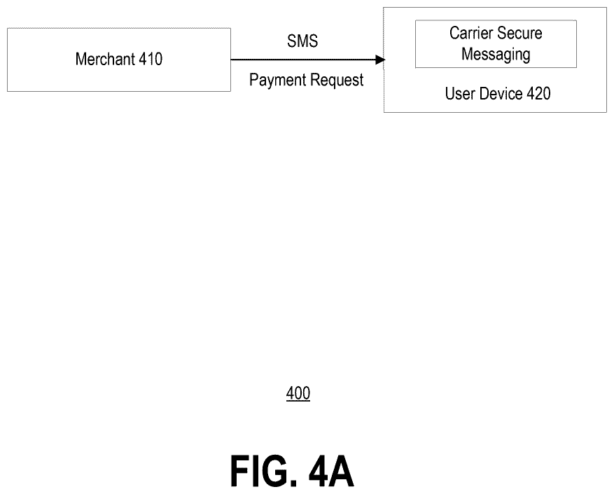

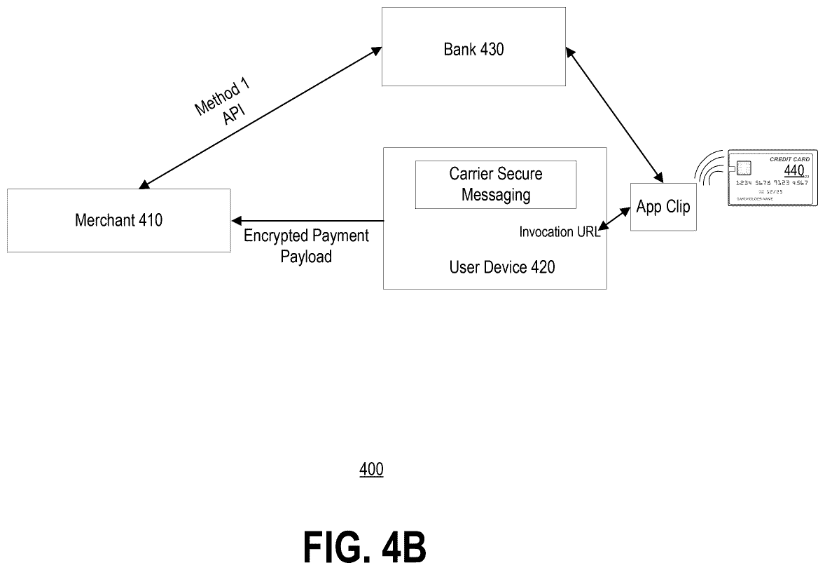

FIGS. 4A and 4B illustrate a diagram 400 of interactions among the system components that can be implemented in the system 100 of FIG. 1 according to an example embodiment. The diagram 400 may comprise two steps. As shown in FIG. 4A, a merchant through a merchant device 410 transmits a SMS message for invoicing a user to a user device 420 used by the user. The SMS may include a payment request for paying one or more transactions conducted by the user with the merchant, a link to a mobile app, instant app, and/or app clip, one or more transaction IDs associated with the one or more transactions respectively, and so forth. The user device 420 may subscribe to a mobile carrier who offers secure messaging service. A trust can be established between the merchant device 410 and the user device 420 through the mobile carrier.

As shown in FIG. 4B, the user may invocate the link (URL) to trigger a download of the mobile app, app clip, and/or instant app. The user may tap a contactless card 440 into the NFC communication field of the user device 420, and the contactless card 440 transmits via the app clip to the user device 420 NFC response information (e.g., a cryptogram) usable by a bank server 430 to authenticate the user and/or contactless card. The NFC response information may be or include, for example, security information encrypted by the contactless card 440 using a private key unique to the card that is known only to the card account administrator (the bank server 430). The cryptogram may be stored in the memory of the contactless card 440. The cryptogram includes the unique identifier of the contactless card 440. The user device 420 transmits the NFC response information (the cryptogram) to the bank server 430. The bank server 430 receives the cryptogram and validates the cryptogram, decrypts the cryptogram and extracts the unique identifier of the contactless card 440 through a card authentication module of the bank server 430. When the bank server 430 receives the cryptogram, the bank server 430 may decrypt the cryptogram before or after verifying the cryptogram. The bank server 430 may verify the unique identifier of the contactless card 440 and retrieve account information of a financial and/or card account based on the unique identifier of the contactless card 440. The bank server 430 may make a payment for the transaction to the merchant device 410 based on the account information of the user. The bank server 430 may provision the account information to the merchant device 410. The bank server 430 may call APIs of the merchant device 410 to make the payment and/or provision the account information (e.g., the method 1 in FIG. 4B). In some embodiments, the bank server 430 may transmit the account information to the user device 420 through the app clip or incorporated SDK with the contactless card logic. The messaging app on the user device 420 may be modified to receive payment information from the app clip or the SDK. The received payment information (e.g., PAN or VCN) can be sent via one or more SMS messages from the user device 420 to the merchant device 410. The payment information or payment payload can be encrypted with the public key to establish merchant trust in the SMS message for invoicing the user, and then decrypted on the merchant's SMS payment processing gateway with the corresponding private key.

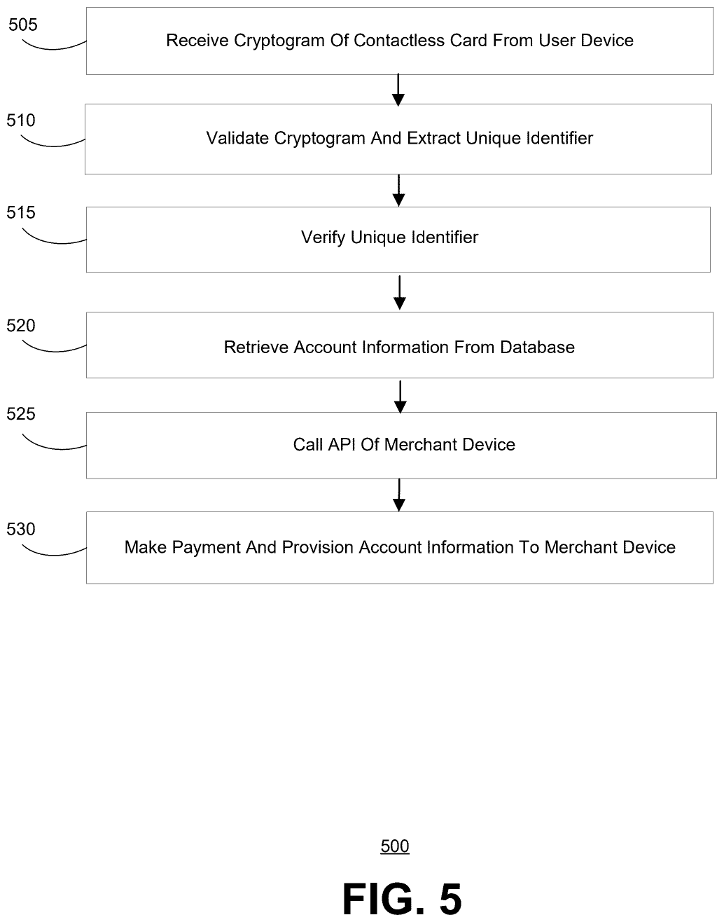

FIG. 5 illustrates a flow chart of an example method 500 for authenticating a user and making a payment using a contactless card according to an example embodiment. FIG. 5 may reference the same or similar components as those illustrated in FIGS. 1-4, including a user device, a server, a database, a merchant device, and a contactless card. The method 500 can be implemented in the system 100 and may include, but is not limited to the following steps.

When a user wants to make an online purchase from a merchant, the user may use a user device (e.g., the user device 120 or 420) to create or log into his or her online account with the merchant is associated with a merchant device (e.g., the merchant device 110 or 410). The merchant may invoice the user using a SMS message with a link that would open up a mobile app or mobile app process on the user device from which the contactless card can be read in that mobile app. By clicking on the link, the user may use the user device to transmit an NFC prompt and/or query to the contactless card. In response, after entry of the contactless card into the NFC communication field of the user device, the contactless card transmits to the user device NFC response information (e.g., a cryptogram) usable by the server to authenticate the user for making a payment. The NFC response information may be or include, for example, security information encrypted by the contactless card using a private key unique to the card that is known only to the card account administrator (the server). The cryptogram may be stored in the memory of the contactless card. The cryptogram includes the unique identifier of the contactless card.

The user device transmits the NFC response information (the cryptogram) the server. At step 505, the server receives the cryptogram from the user device. The server validates the cryptogram, decrypts the cryptogram and extracts the unique identifier of the contactless card through the card authentication module of the server at step 510. When the server receives the cryptogram, the server may decrypt the cryptogram before or after verifying the cryptogram. The server may then extract the unique identifier of the contactless card which is uniquely associated with the user. At step 515, the server may verify the unique identifier of the contactless card by searching the database. Then at step 520, the server may authenticate the user based on the unique identifier of the contactless card and retrieve the account information of the user from the database.

At step 525, the server may call the APIs of the merchant device as described above. At step 530, the server make a payment and/or provision the account information to the merchant device through the APIs of the merchant device.

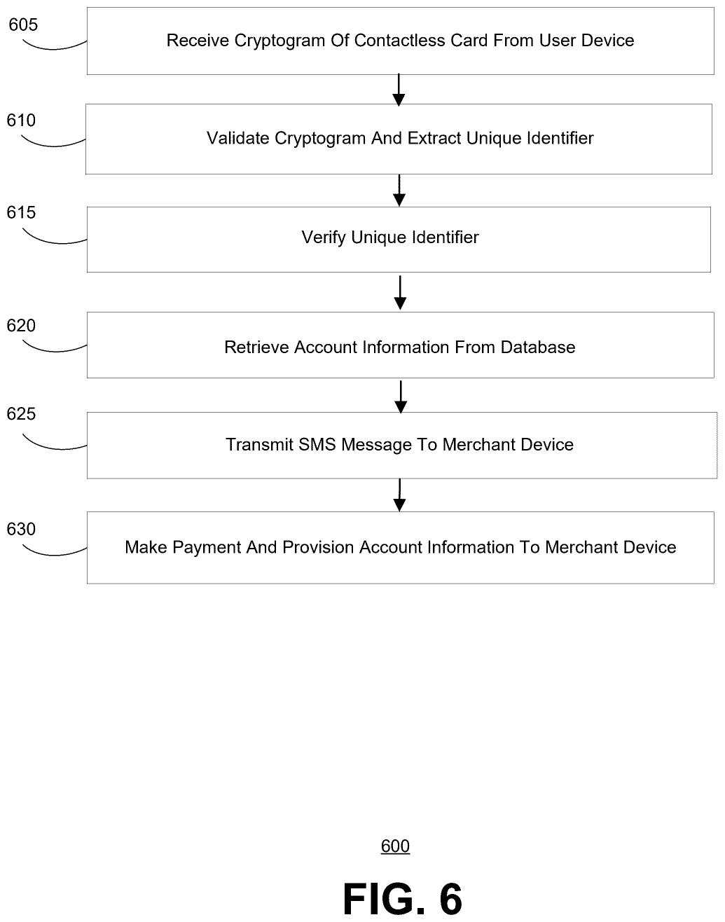

FIG. 6 illustrates a flow chart of an example method 600 for authenticating a user and making a payment according to an example embodiment. FIG. 6 may reference the same or similar components as those illustrated in FIGS. 1-5, including a user device, a server, a database, a merchant device, and a contactless card. The method 600 can be implemented in the system 100 and may include, but is not limited to the following steps.

As described above,, when a user wants to make an online purchase from a merchant, the user may use a user device (e.g., the user device 120 or 420) to create or log into his or her online account with the merchant is associated with a merchant device (e.g., the merchant device 110 or 410). The merchant may invoice the user using a SMS message with a link that would open up a mobile app or mobile app process on the user device from which the contactless card can be read in that mobile app. By clicking on the link, the user may use the user device to transmit an NFC prompt and/or query to the contactless card. In response, after entry of the contactless card into the NFC communication field of the user device, the contactless card transmits to the user device NFC response information (e.g., a cryptogram) usable by the server to authenticate the user for making a payment. The NFC response information may be or include, for example, security information encrypted by the contactless card using a private key unique to the card that is known only to the card account administrator (the server). The cryptogram may be stored in the memory of the contactless card. The cryptogram includes the unique identifier of the contactless card.

The user device transmits the NFC response information (the cryptogram) the server. At step 605, the server receives the cryptogram from the user device. The server validates the cryptogram, decrypts the cryptogram and extracts the unique identifier of the contactless card through the card authentication module of the server at step 610. When the server receives the cryptogram, the server may decrypt the cryptogram before or after verifying the cryptogram. The server may then extract the unique identifier of the contactless card which is uniquely associated with the user. At step 615, the server may verify the unique identifier of the contactless card by searching the database. Then at step 620, the server may authenticate the user based on the unique identifier of the contactless card and retrieve the account information of the user from the database.

At step 625, the server may transmit a SMS message including the account information of the user. The SMS message may include the transaction ID and the payment selection. The account information may be encrypted for further security. At step 630, the server make a payment and/or provision the account information to the merchant device through the SMS message.

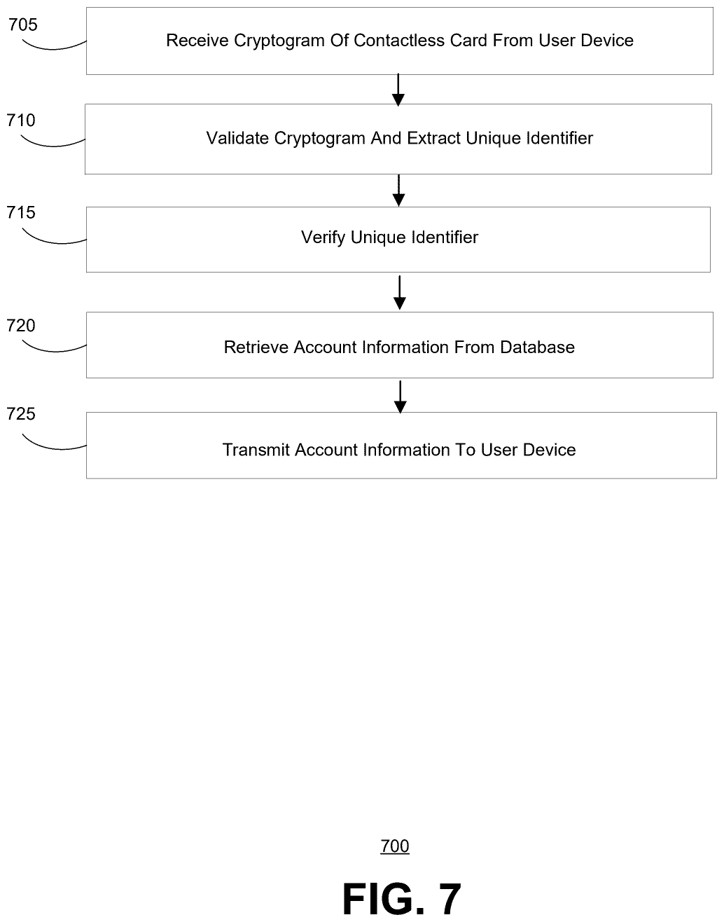

FIG. 7 illustrates a flow chart of an example method 700 for authenticating a user and making a payment using a contactless card according to an example embodiment. FIG. 7 may reference the same or similar components as those illustrated in FIGS. 1-6, including a user device, a server, a database, a merchant device, and a contactless card. The method 700 can be implemented in the system 100 and may include, but is not limited to the following steps.

As described above,, when a user wants to make an online purchase from a merchant, the user may use a user device (e.g., the user device 120 or 420) to create or log into his or her online account with the merchant is associated with a merchant device (e.g., the merchant device 110 or 410). The merchant may invoice the user using a SMS message with a link that would open up a mobile app or mobile app process on the user device from which the contactless card can be read in that mobile app. By clicking on the link, the user may use the user device to transmit an NFC prompt/query to the contactless card. In response, after entry of the contactless card into the NFC communication field of the user device, the contactless card transmits to the user device NFC response information (e.g., a cryptogram) usable by the server to authenticate the user for making a payment. The NFC response information may be or include, for example, security information encrypted by the contactless card using a private key unique to the card that is known only to the card account administrator (the server). The cryptogram may be stored in the memory of the contactless card. The cryptogram includes the unique identifier of the contactless card.

The user device transmits the NFC response information (e.g., the cryptogram) the server. At step 705, the server receives the cryptogram from the user device. The server validates the cryptogram, decrypts the cryptogram and extracts the unique identifier of the contactless card through the card authentication module of the server at step 710. When the server receives the cryptogram, the server may decrypt the cryptogram before or after verifying the cryptogram. The server may then extract the unique identifier of the contactless card which is uniquely associated with the user. At step 715, the server may verify the unique identifier of the contactless card by searching the database. Then at step 720, the server may authenticate the user based on the unique identifier of the contactless card and retrieve the account information of the user from the database.

At step 725, the server may transmit the account information to the user device. The transmission may be a SMS message including the account information of the user. The SMS message may include the transaction ID. The account information may be encrypted for further security. Alternatively, the transmission may be conducted through one or more APIs of the server.

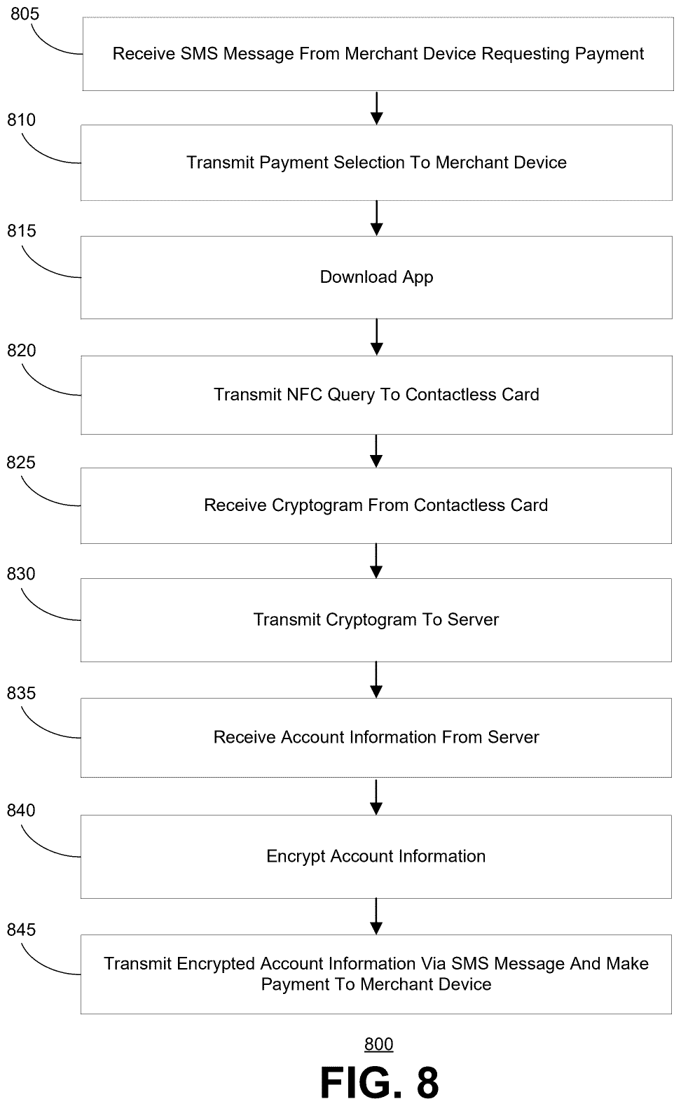

FIG. 8 illustrates a flow chart of an example method 800 for authenticating a user and making a payment using a contactless card according to an example embodiment. FIG. 8 may reference the same or similar components as those illustrated in FIGS. 1-7, including a user device, a server, a database, a merchant device, and a contactless card. The method 800 can be implemented in the system 100 and may include, but is not limited to the following steps.

When a user wants to make an online purchase from a merchant, the user may use the user device 120 to log into his or her online account with the merchant that is associated with the merchant device 110. In those example embodiments, the merchant device 110 may invoice the user by transmitting to the user device 120 a SMS message requesting a payment for the transaction. At step 805, the user device 120 receives the SMS message from the merchant device 110 requesting the payment. The SMS message is transmitted through the carrier of the user device 120 (such as a mobile phone carrier offering SMS text message service), thus the SMS message can be certified to be from the merchant, whereby a trust is created between the merchant and the user. The SMS message may contain a universal link (e.g., a deep link or app clip), and/or a transaction ID indicating the transaction. The SMS message may also include payment choices, such as a one-time payment or a stored card recurring payment. At step 810, the user may select a payment option from the payment choices, and transmit through the user device 120 the payment selection to the merchant device 110.

The universal link in the SMS message may then open up a mobile app or mobile app process on the user device 120 from which the contactless card 160 can be read in that mobile app. If the mobile app is not already installed on the user device 120, the link may trigger a download activation to download the mobile app and install it on the user device 120 at step 815. The user may use the user device 120 to transmit an NFC prompt and/or query to the contactless card 160 at step 820. The user device 120 may include an NFC interface configured for establishing an NFC communication with other NFC-equipped devices (the contactless card 160 in this embodiment). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the contactless card 160 transmits to the user device 120 NFC response information (e.g., a cryptogram) usable by the server 130 to authenticate the user and/or contactless card. Accordingly, the user device 120 receives the cryptogram from the contactless card 160 at step 825. The NFC response information may be or include, for example, security information encrypted by the contactless card 160 using a private key unique to the card that is known only to the card account administrator (the server 130). The cryptogram may be stored in the memory of the contactless card 160. The cryptogram includes the unique identifier of the contactless card 160.

At step 830, the user device 120 transmits the NFC response information (the cryptogram) to the server 130. The server 130 receives the cryptogram from the user device 120. The server 130 validates the cryptogram, decrypts the cryptogram and extracts the unique identifier of the contactless card 160 through the card authentication module of the server 130. When the server receives the cryptogram, the server may decrypt the cryptogram before or after verifying the cryptogram. The server 130 may then extract the unique identifier of the contactless card 160 which is uniquely associated with the user. The server 130 may verify the unique identifier of the contactless card 160 by searching the database 140. Then the server 130 may retrieve account information of a financial and/or card account based on the unique identifier of the contactless card 160 from the database 140. The account information may include, but is not limited to, a PAN of the financial and/or card account, a VCN of the card, a home address of the user, a mailing address of the user, a phone number of the user, a billing address of the user, and so forth.

The server 130 may transmit the account information to the user device 120. Accordingly, the user device 120 may receive the account information from the server 130 at step 835. At step 840, the user device 120 may encrypt the account information. At step 845, the user device 120 may transmit the encrypted account information via a SMS message to the merchant device and make a payment for the transaction based on the account information of the user. The payment may be a one-time payment according to the user selection of payment choices. If the payment is a recurring payment or the user would like to have his or her account information stored with the merchant, the user device 120 may provision the account information to the merchant device 110. In some embodiments, the user device 120 may make the payment and/or provision the account information via one or more SMS messages to the merchant device 110.

As described above, when the user uses the user device 120 to initiate a transaction with the merchant device 110 and then receives a payment request via a SMS message including a link from the merchant device 110, the user can be directed to use a mobile app installed on the user device or downloaded to the user device to read the contactless card 160 for authenticating the user for making the payment and/or provisioning the account information. The SMS message with the link would open up the mobile app or mobile app process and the user would be able to read the contactless card 160 in that mobile app and then that contactless card data would go back to the server 130, so the server 130 would be able to verify the user using the contactless card 160 for making the payment and/or provisioning the account information.

In some embodiments, the link with a deep link may be transmitted into the mobile app of the user device 120, and the user can follow the link to tap the contactless card 160. In such scenarios, the user does not have to fully log in the mobile app installed on the user device 120. The user just taps the contactless card 160 to the user device 120 and the server 130 is going back to verify the user using the contactless card 160 for making the payment and/or provisioning the account information.

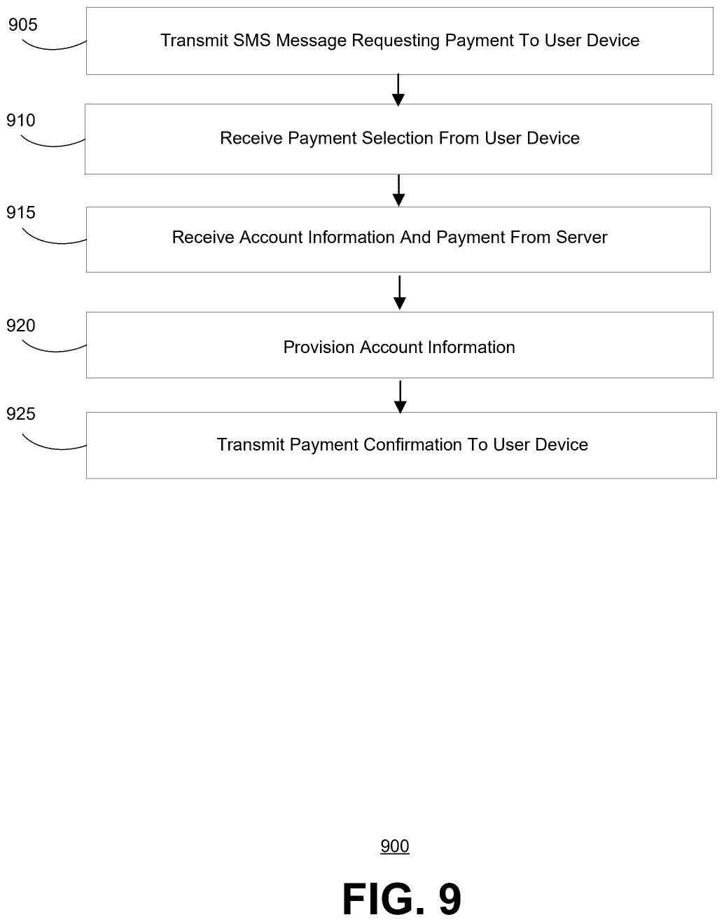

FIG. 9 illustrates a flow chart of an example method 900 for authenticating a user and making a payment using a contactless card according to an example embodiment. FIG. 9 may reference the same or similar components as those illustrated in FIGS. 1-8, including a user device, a server, a database, a merchant device, and a contactless card. The method 900 can be implemented in the system 100 and may include, but is not limited to the following steps.

As described above, when a user wants to make an online purchase from a merchant, the user may use the user device 120 to log into his or her online account with the merchant that is associated with the merchant device 110. In those example embodiments, the merchant device 110 may invoice the user by transmitting to the user device 120 a SMS message requesting a payment for the transaction at step 905. The SMS message is transmitted through the carrier of the user device 120 (such as a mobile phone carrier offering SMS text message service), thus the SMS message can be certified to be from the merchant, whereby a trust is created between the merchant and the user. The SMS message may contain a universal link (e.g., a deep link or app clip), and/or a transaction ID indicating the transaction. The SMS message may also include payment choices, such as a one-time payment or a stored card recurring payment. The user may select a payment option from the payment choices, and transmit through the user device 120 the payment selection to the merchant device 110. Accordingly, the merchant device 110 may receive the payment selection from the user device 120 at step 910.

The universal link in the SMS message may then open up a mobile app or mobile app process on the user device 120 from which the contactless card 160 can be read in that mobile app. If the mobile app is not already installed on the user device 120, the link may trigger a download activation to download the mobile app and install it on the user device 120. The user may use the user device 120 to transmit an NFC prompt and/or query to the contactless card 160. The user device 120 may include an NFC interface configured for establishing an NFC communication with other NFC-equipped devices (the contactless card 160 in this embodiment). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the contactless card 160 transmits to the user device 120 NFC response information (e.g., a cryptogram) usable by the server 130 to authenticate the user and/or contactless card. The NFC response information may be or include, for example, security information encrypted by the contactless card 160 using a private key unique to the card that is known only to the card account administrator (the server 130). The cryptogram may be stored in the memory of the contactless card 160. The cryptogram includes the unique identifier of the contactless card 160.

The user device 120 transmits the NFC response information (the cryptogram) to the server 130. The server 130 receives the cryptogram from the user device 120. The server 130 validates the cryptogram, decrypts the cryptogram and extracts the unique identifier of the contactless card 160 through the card authentication module of the server 130. When the server receives the cryptogram, the server may decrypt the cryptogram before or after verifying the cryptogram. The server 130 may then extract the unique identifier of the contactless card 160 which is uniquely associated with the user. The server 130 may verify the unique identifier of the contactless card 160 by searching the database 140. Then the server 130 may retrieve account information of a financial and/or card account based on the unique identifier of the contactless card 160 from the database 140. The account information may include, but is not limited to, a PAN of the financial and/or card account, a VCN of the card, a home address of the user, a mailing address of the user, a phone number of the user, a billing address of the user, and so forth.

The server 130 may make a payment for the transaction to the merchant based on the account information of the user. The payment may be a one-time payment according to the user selection of payment choices. If the payment is a recurring payment or the user would like to have his or her account information stored with the merchant, the server 130 may transmit the account information to the merchant device 110. The server 130 may call APIs of the merchant device to make the payment and/or transmit the account information. In some embodiments, the server 130 may make the payment and/or transmit the account information via one or more SMS messages to the merchant device 110. Accordingly, the merchant device 110 the account information and payment from the server 130 at step 915.

At step 920, the merchant device 110 may provision the received account information to the user's account associated with the merchant. At step 925, the merchant device 110 may transmit a SMS message including a payment confirmation to the user via the user device 120. After the merchant device 110 receives the payment from the server 130, the merchant device 110 may notify the user of the payment by transmitting the SMS message including the payment confirmation to the user device 120.

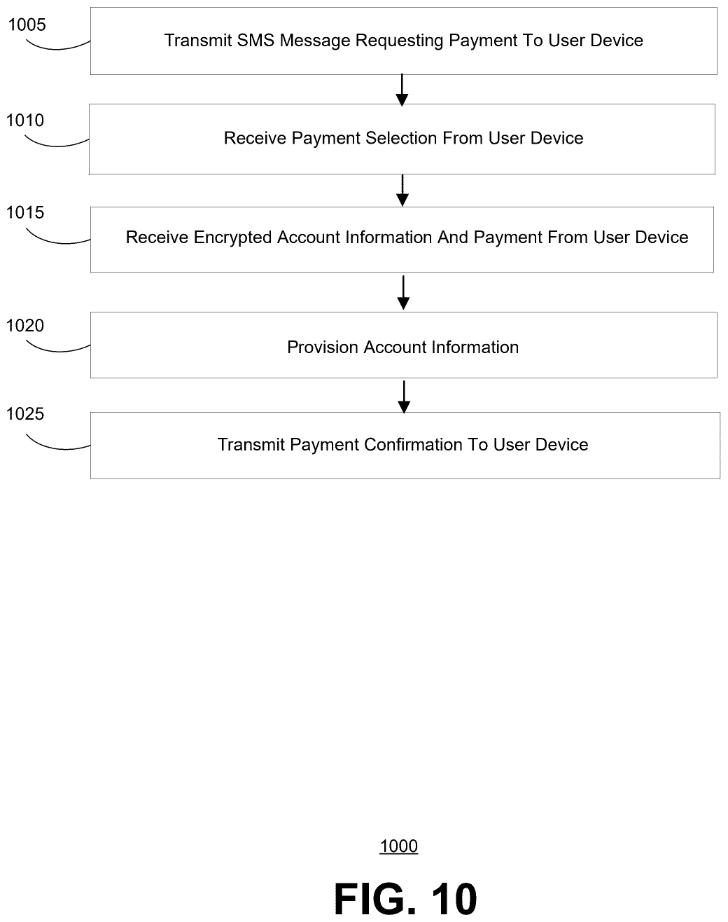

FIG. 10 illustrates a flow chart of an example method 1000 for authenticating a user and making a payment using a contactless card according to an example embodiment. FIG. 10 may reference the same or similar components as those illustrated in FIGS. 1-9, including a user device, a server, a database, a merchant device, and a contactless card. The method 1000 can be implemented in the system 100 and may include, but is not limited to the following steps.

As described above, when a user wants to make an online purchase from a merchant, the user may use the user device 120 to log into his or her online account with the merchant that is associated with the merchant device 110. In those example embodiments, the merchant device 110 may invoice the user by transmitting to the user device 120 a SMS message requesting a payment for the transaction at step 1005. The SMS message is transmitted through the carrier of the user device 120 (such as a mobile phone carrier offering SMS text message service), thus the SMS message can be certified to be from the merchant, whereby a trust is created between the merchant and the user. The SMS message may contain a universal link (e.g., a deep link or app clip), and/or a transaction ID indicating the transaction. The SMS message may also include payment choices, such as a one-time payment or a stored card recurring payment. The user may select a payment option from the payment choices, and transmit through the user device 120 the payment selection to the merchant device 110. Accordingly, the merchant device 110 may receive the payment selection from the user device 120 at step 1010.

The universal link in the SMS message may then open up a mobile app or mobile app process on the user device 120 from which the contactless card 160 can be read in that mobile app. If the mobile app is not already installed on the user device 120, the link may trigger a download activation to download the mobile app and install it on the user device 120. The user may use the user device 120 to transmit an NFC prompt and/or query to the contactless card 160. The user device 120 may include an NFC interface configured for establishing an NFC communication with other NFC-equipped devices (the contactless card 160 in this embodiment). In some of these embodiments, the NFC interface of the user device 120 may be or include an NFC receiver configured for selectively activating a magnetic field for use in establishing near field communication with an NFC transmitter. The NFC interface of the user device 120 is configured for establishing NFC communication when a passive NFC tag or other NFC-enabled device is brought into the magnetic field and within the NFC communication range of the user device 120. The NFC interface of the user device 120 is configured, in particular, for communication with the NFC-enabled card 160 when the card 160 is brought within communication range of the user device 120 (such as, the contactless card 160 is tapped by the user to the user device 120). As used herein, a tap of the contactless card 160 to the user device 120 may not indicate that the contactless card 160 is in a physical contact with the user device 120. A tap of the contactless card 160 to the user device 120 may refer to entry of the contactless card 160 into the NFC communication field of the user device 120.

In response, after entry of the contactless card 160 into the NFC communication field of the user device 120, the contactless card 160 transmits to the user device 120 NFC response information (e.g., a cryptogram) usable by the server 130 to authenticate the user and/or contactless card. The NFC response information may be or include, for example, security information encrypted by the contactless card 160 using a private key unique to the card that is known only to the card account administrator (the server 130). The cryptogram may be stored in the memory of the contactless card 160. The cryptogram includes the unique identifier of the contactless card 160.

The user device 120 transmits the NFC response information (e.g., the cryptogram) to the server 130. The server 130 receives the cryptogram from the user device 120. The server 130 validates the cryptogram, decrypts the cryptogram and extracts the unique identifier of the contactless card 160 through the card authentication module of the server 130. When the server receives the cryptogram, the server may decrypt the cryptogram before or after verifying the cryptogram. The server 130 may then extract the unique identifier of the contactless card 160 which is uniquely associated with the user. The server 130 may verify the unique identifier of the contactless card 160 by searching the database 140. Then the server 130 may retrieve account information of a financial and/or card account based on the unique identifier of the contactless card 160 from the database 140. The account information may include, but is not limited to, a PAN of the financial and/or card account, a VCN of the card, a home address of the user, a mailing address of the user, a phone number of the user, a billing address of the user, and so forth. The server 130 may transmit the account information to the user device 120. Accordingly, the user device 120 may receive the account information from the server 130. The user device 120 may encrypt the account information. The user device 120 may transmit the encrypted account information via a SMS message to the merchant device 110 and make a payment for the transaction based on the account information of the user. The payment may be a one-time payment according to the user selection of payment choices. If the payment is a recurring payment or the user would like to have his or her account information stored with the merchant, the user device 120 may transmit the account information to the merchant device 110. In some embodiments, the user device 120 may make the payment and/or provision the account information via one or more SMS messages to the merchant device 110. Accordingly, the merchant device 110 receives the encrypted account information and payment from the user device 120 at step 1015.

In some embodiments, the user device 120 may call APIs of the merchant device 110 to make the payment and/or transmit the account information. At step 1020, the merchant device 110 may provision the received account information to the user's account associated with the merchant. At step 1025, the merchant device 110 may transmit a SMS message including a payment confirmation to the user via the user device 120. After the merchant device 110 receives the payment from the user device 120, the merchant device 110 may notify the user of the payment by transmitting the SMS message including the payment confirmation to the user device 120.

In some embodiments, a customer may be in person buying something using a contactless card, and provide his or her phone number to the merchant. To add more high security, the user may be required to use an app on the user device and be required to log in to the app, which can have an additional factor authentication from the user. The user device reads the contactless card through the app. In some embodiments, the merchant is not required to have a payment terminal. The merchant just uses another device in their end for sending the payment request SMS message and receiving the payment. In some embodiments, a customer may provide his/her phone number to a merchant in person. For example, the merchant could have a Etsy shop or whatever setup, and the customer is in person, the merchant may just say to the customer “what's your phone number?”, then the merchant would then put the phone information on the Etsy site, and the Etsy site would then send a payment request SMS message out to the phone and then complete the transaction.

As described, when a customer is going through customer checkout, the present disclosure provides a secure way to be able to finalize a transaction using a contactless card. The customer may enter in his or her phone number and email address on a website associated with a merchant. A SMS message may be sent over from the merchant to the customer that would show up on a mobile phone of the customer. The SMS message may include payment request information, the transaction ID, a URL link, and so on. The URL link in that SMS message would allow the customer to either launch the app if the app is installed on the mobile phone or make a successive launch of the app clip or an instant app if the app is not already installed on the mobile phone. The app, app clip, and/or instant app may display some prompts to tap the contactless card, for example, it might display what the transaction is and the transition amount. The user can tap the contactless card to the mobile device via the app/app clip, and/or instant app, and authentication of the card and/or customer would be done with a bank server. Once that authentication is done, the customer would be able to send all the financial account data associated with a bank account of the customer to the merchant over the bank server or the mobile device. The merchant at that point then would be able to issue an SMS message to the mobile device indicating that the transaction is complete. The customer would get the authentication message coming over from the merchant via SMS OTP.

In some aspects, the techniques described herein relate to a method for secure merchant payment over a messaging platform based on a contactless card, including: receiving, by a server via a user device, a cryptogram from a contactless card; validating, by the server, the cryptogram; extracting, by the server from the cryptogram, a unique customer identifier associated with a user; verifying, by the server, the unique customer identifier; retrieving, by the server from a database, account information of the user; calling, by the server, an application programming interface (API) of a merchant device to make a payment in response to a payment request message received from the merchant device; and provisioning, by the server, the account information to the merchant device via the API.

In some aspects, the techniques described herein relate to a method, wherein the account information includes one or more of a name of the user, a phone number of the user, a home address of the user, a mailing address of the user, a primary account number (PAN) of the user, and a virtual card number (VCN) of the user.

In some aspects, the techniques described herein relate to a method, wherein the payment request message includes a deep link or app clip, a transaction ID, and payment options.

In some aspects, the techniques described herein relate to a method, wherein the user is prompted to tap the contactless card to the user device upon clicking on the deep link or app clip.

In some aspects, the techniques described herein relate to a method, wherein the API is called with the account information and a transaction ID.

In some aspects, the techniques described herein relate to a method, wherein the contactless card includes a processor and a memory, the memory storing the cryptogram that contains the unique customer identifier.

In some aspects, the techniques described herein relate to a method, wherein: the memory of the contactless card further contains a counter value and a plurality of keys, and the processor of the contactless card is configured to generate the cryptogram using the counter value, the plurality of keys, and the unique customer identifier.

In some aspects, the techniques described herein relate to a method, wherein the processor of the contactless card is configured to update the counter value.

In some aspects, the techniques described herein relate to a method, further including transmitting, by the server, the account information to the user device, wherein the user device encrypts the account information and transmits the encrypted account information to the merchant device to make the payment in response to the payment request message.

In some aspects, the techniques described herein relate to a method, further including transmitting, by the server via a SMS message, the account information to the merchant device to make the payment in response to the payment request message.

In some aspects, the techniques described herein relate to a method, wherein the user device receives the payment request message from the merchant device, and the user device receives the cryptogram from the contactless card upon tapping the contactless card to the user device by the user prompted by the payment request message.

In some aspects, the techniques described herein relate to a system for secure merchant payment over a messaging platform based on a contactless card, including a server, the server configured to: receive, via a user device, a cryptogram from a contactless card; validate the cryptogram; extract, from the cryptogram, a unique customer identifier associated with a user; verify the unique customer identifier; retrieve, from a database, account information of the user; call one or more application programming interfaces (APIs) of a merchant device to make a payment in response to a payment request message received from the merchant device; and provision the account information to the merchant device via the APIs.

In some aspects, the techniques described herein relate to a system, wherein the account information includes one or more of a name of the user, a phone number of the user, a home address of the user, a mailing address of the user, a primary account number (PAN) of the user, and a virtual card number (VCN) of the user.

In some aspects, the techniques described herein relate to a system, wherein the payment request message includes a deep link or app clip, a transaction ID, and payment options.

In some aspects, the techniques described herein relate to a system, wherein the user is prompted to tap the contactless card to the user device upon clicking on the deep link or app clip.

In some aspects, the techniques described herein relate to a system, wherein the APIs are called with the account information and a transaction ID.

In some aspects, the techniques described herein relate to a system, wherein the contactless card includes a processor and a memory, the memory storing the cryptogram that contains the unique customer identifier.

In some aspects, the techniques described herein relate to a system, wherein: the memory of the contactless card further contains a counter value and a plurality of keys, and the processor of the contactless card is configured to generate the cryptogram using the counter value, the plurality of keys, and the unique customer identifier.

In some aspects, the techniques described herein relate to a system, wherein the user device receives a payment request message from a merchant device, and the user device receives the cryptogram from the contactless card upon taping the contactless card to the user device by the user prompted by the payment request message.

In some aspects, the techniques described herein relate to a non-transitory, computer-readable medium including instructions for secure merchant payment over a messaging platform based on a contactless card that, when executed on a computer arrangement, perform actions including: receiving, via a user device, a cryptogram from a contactless card; validating the cryptogram; extracting, from the cryptogram, a unique customer identifier associated with a user; verifying the unique customer identifier; retrieving, from a database, account information of the user; calling one or more application programming interfaces (APIs) of a merchant device to make a payment in response to a payment request message received from the merchant device; and provisioning the account information to the merchant device via the APIs.

Throughout the disclosure, the term merchant is used, and it is understood that the present disclosure is not limited to a particular merchant or type of merchant. Rather, the present disclosure includes any type of merchant, vendor, or other entity involving in activities where products or services are sold or otherwise provided.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit). Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-20. (canceled)

21. A non-transitory, computer-readable medium comprising instructions for secure payment that, when executed on a network-enabled computer device, cause the network-enabled computer device to perform procedures comprising:
extracting, from a cryptogram, a unique customer identifier associated with a user;
verifying the unique customer identifier;
retrieving, from a database, account information of the user;
calling one or more application programming interfaces (APIs) of a merchant device to make a payment; and
provisioning the account information to the merchant device via the one or more APIs.

22. The non-transitory, computer-readable medium of claim 21, wherein calling one or more APIs of the merchant device to make the payment is in response to a payment message received from the merchant device.

23. The non-transitory, computer-readable medium of claim 21, the procedures further comprising:
receiving, via a user device, the cryptogram from a contactless card; and
validating the cryptogram.

24. The non-transitory, computer-readable medium of claim 23, wherein the cryptogram is validated prior to extracting the unique customer identifier.

25. The non-transitory, computer-readable medium of claim 23, the procedures further comprising decrypting the cryptogram using a private key.

26. The non-transitory, computer-readable medium of claim 25, wherein the private key is unique to the contactless card.

27. The non-transitory, computer-readable medium of claim 25, wherein the cryptogram is decrypted prior to validation.

28. The non-transitory, computer-readable medium of claim 25, wherein the cryptogram is decrypted after validation.

29. The non-transitory, computer-readable medium of claim 21, wherein the payment request message comprises a deep link or app clip, a transaction identification (ID), and payment options.

30. The non-transitory, computer-readable medium of claim 27, wherein the user is prompted to tap the contactless card to the user device upon clicking on the deep link or app clip.

31. The non-transitory, computer-readable medium of claim 21, wherein the account information comprises at least one selected from the group of a name of the user, a phone number of the user, a home address of the user, a mailing address of the user, and a primary account number (PAN) of the user.

32. The non-transitory, computer-readable medium of claim 21, wherein the account information comprises a virtual card number (VCN) of the user.

33. A system for secure payment, comprising:
a network-enabled computer device, comprising:
a processor, and
a memory, the memory storing a cryptogram,
wherein the network-enabled computer device is configured to:
extract, from the cryptogram, a unique customer identifier associated with a user,
verifying the unique customer identifier,
retrieve, from a database, account information of the user;
call one or more application programming interfaces (APIs) of a merchant device to make a payment; and
provision the account information to the merchant device via the one or more APIs.

34. The system of claim 33, wherein the network-enabled computer device comprises a server.

35. The system of claim 33, wherein the network-enabled computer device comprises a phone.

36. The system of claim 33, further comprising:
the contactless card, wherein the contactless card comprises a processor and a memory,
the memory storing the cryptogram, the unique customer identifier, one or more keys, and a counter value,
wherein the contactless card is configured to generate the cryptogram using the unique customer identifier, the one or more keys, and the counter value.

37. A method for secure payment, comprising:
extracting, by a network-enabled computer device from a cryptogram, a unique customer identifier associated with a user;
verifying, by the network-enabled computer device, the unique customer identifier;
retrieving, by the network-enabled computer device from a database, account information of the user;
calling, by the network-enabled computer device, one or more application programming interfaces (APIs) of a merchant device to make a payment; and
provisioning, by the network-enabled computer device, the account information to the merchant device via the one or more APIs.

38. The method of claim 37, wherein the network-enabled computer device calls the one or more APIs with the account information and a transaction identification (ID).

39. The method of claim 37, further comprising:
receiving, by the network-enabled computer device via a user device, the cryptogram from a contactless card; and
validating, the network-enabled computer device, the cryptogram.

40. The method of claim 39, wherein the network-enabled computer device is associated with an institution issuing the contactless card.
